(19) United States
(12) Patent Application Publication
(10) Pub. No.: US 2017/0123562 A1
(43) Pub. Date: May 4, 2017

(54) COMMUNICATION WITH A CAPACITIVE TOUCH-SCREEN

(71) Applicant: Microsoft Technology Licensing, LLC, Redmond, WA (US)

(72) Inventors: Daniel Cletheroe, Stapleford (GB); Nicolas Villar, Cambridge (GB); Greg Saul, Cambridge (GB); Christian Holz, Seattle, WA (US); Haiyan Zhang, Cambridge (GB)

(21) Appl. No.: 15/231,655

(22) Filed: Aug. 8, 2016

Related U.S. Application Data
(63) Continuation-in-part of application No. 14/931,049, filed on Nov. 3, 2015.

(51) Int. Cl. G06F 3/041; G06F 3/0362; G06F 3/0354; G06F 3/044

(52) U.S. Cl. CPC G06F 3/0416; G06F 3/044; G06F 3/0362; G06F 3/0354; G06F 2203/0381; G06F 2203/04106; H01Q 1/243

(57) ABSTRACT

An object for use with a capacitive-touch-sensing device comprises a plurality of conductive regions on a single face of the object and a switching arrangement connected to the plurality of conductive regions. The switching arrangement is configured to change a capacitive footprint of the face of the object, for example, by selectively connecting (e.g. shorting) together two or more conductive regions.

### CROSS-REFERENCE TO RELATED APPLICATION

This non-provisional utility application is a continuation-in-part of U.S. application Ser. No. 14/931,049 entitled “Multi-modal Sensing Surface” and filed on Nov. 3, 2015, which is incorporated herein in its entirety by reference.

### BACKGROUND

There are many different technologies which can be used to produce a touch-sensitive surface including capacitive or resistive sensing and optical techniques. Capacitive multi-touch surfaces can detect the positions of one or more fingers on the surface, but cannot uniquely identify objects placed on the surface. Optical multi-touch tables, which use a camera/projector system or sensor-in-pixel technology, have the ability to identify objects equipped with a visual marker as well as sense multi-touch user input, but are typically large and have a high power consumption.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

An object for use with a capacitive-touch-sensing device comprises a plurality of conductive regions on a single face of the object and a switching arrangement connected to the plurality of conductive regions. The switching arrangement is configured to change a capacitive footprint of the face of the object, for example, by selectively connecting (e.g. shorting) together two or more conductive regions.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram showing a touch-sensitive surface device and an object arranged to communicate with the touch-sensitive surface device;

FIG. 2 is a schematic diagram showing the sensing mat from a sensing surface device in more detail;

FIG. 3 shows schematic diagrams of an example of the object of FIG. 1 and its operation in more detail;

FIG. 4 is a flow diagram showing an example method of operation of the touch-sensitive surface device of FIG. 1;

FIG. 5 is a schematic diagram showing an example switching arrangement;

FIG. 6 shows schematic diagrams of further examples of the object of FIG. 1 in more detail;

FIG. 7 shows a schematic diagram of another example of the object of FIG. 1; and

FIG. 8 shows a schematic diagram of a yet further example of the object of FIG. 1 in more detail.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

As described above, touch-sensitive surfaces which use capacitive sensing can detect a user's fingers on the surface but cannot uniquely identify an object placed on the surface. In order for an object on the touch-sensitive surface to communicate with the surface, a separate communication channel is used, such as Bluetooth™, and this requires significantly more power than the capacitive sensing arrangement. The embodiments described below are not limited to implementations which solve any or all of the disadvantages of known sensing surfaces.

Described herein is an object which, when placed on a touch-sensitive surface that uses capacitive sensing, can communicate with the touch-sensitive surface using capacitive sensing only. The data that is communicated may be a single bit of data (e.g. which is used as an interrupt to trigger an action with the touch-sensitive surface) or may be more than one bit of data. The object comprises a plurality of conductive regions on a single face of the object. Each conductive region (which may alternatively be referred to as an electrode) is connected to a switching arrangement which may be manually or automatically controlled (e.g. by a microcontroller). The switching arrangement is configured to selectively change a capacitive footprint of the object, e.g. by selectively short circuiting or otherwise connecting two or more of the conductive regions together and/or by changing the relative position of two or more of the conductive regions and various examples are described in more detail below. Where the switching arrangement is controlled manually, it is a latching switching arrangement such that it does not require a user to be touching the object in order for it to be able to communicate with a touch-sensitive surface (i.e. the user does not form part of the electrical circuit, unlike when detecting touch-input).

The term ‘capacitive footprint’ is used herein to refer to the pattern which is detectable by a capacitive sensing electrode array when the object is placed in contact with the array. As described herein, the footprint is a consequence of the arrangement of conductive regions on the face of the object which is in contact with the capacitive sensing electrode array and any electrical connections between the conductive regions.

By using the switching arrangement, the object can communicate with the touch-sensitive surface in a very low power manner and where the switching arrangement is operated manually, the object may not consume any power. As described above, the communication does not rely on a user touching the object in order to be able to communicate (and hence can occur when a user is not touching the object) and consequently, multiple objects (e.g. three or more objects) can communicate with the touch-sensitive surface substantially in parallel and/or the object can communicate automatically (e.g. where the switching arrangement is controlled by a microcontroller or other processing element) and/or the communication can occur in parallel with standard touch-events (e.g. by a user's fingers on the touch-sensitive surface device).

As described in more detail below, in various examples the object may comprise three or more separate conductive regions arranged in a pattern that means that the object can be placed at any rotational orientation on the touch-sensitive surface and still operate. Use of three or more separate conductive regions may also provide an improved signal to noise ratio.

Described herein is also a touch-sensitive surface device comprising a capacitive sensing electrode array which is configured to receive data from an object placed on the surface, where data is communicated through changing the capacitive footprint of the object. In particular, the surface device comprises a sensing module coupled to the capacitive sensing electrode array and which is configured to compare a first capacitive footprint of an object detected using the capacitive sensing electrode array at a first time (e.g. in a first frame) to one or more reference footprints (e.g. an ‘on’ reference footprint and an ‘off’ reference footprint) or to a second capacitive footprint of the object detected using the capacitive sensing electrode array at a second time (e.g. in a second frame). Where reference footprints are used, the sensing module determines whether the first capacitive footprint matches one of the reference footprints and where a second capacitive footprint is used, the sensing module determines whether the first and second capacitive footprints are the same or different. The sensing module may be implemented in hardware and/or software.

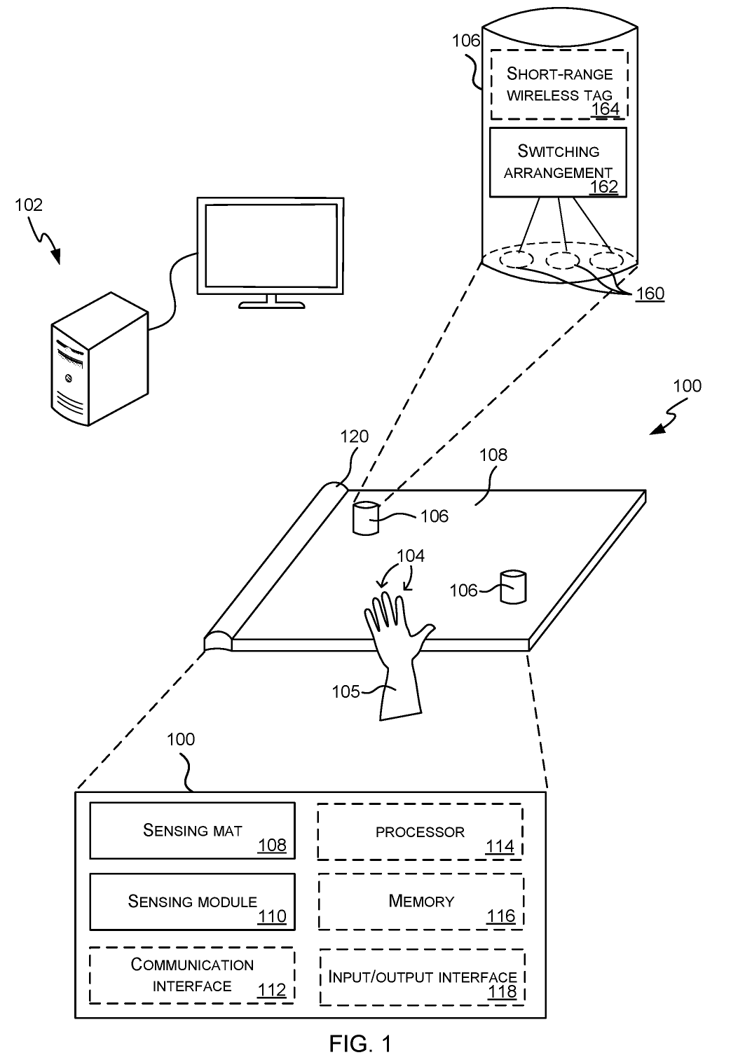

FIG. 1 is a schematic diagram showing a touch-sensitive surface device 100 which may be integrated within a computing device or may operate as a peripheral device (e.g. an input device) for a separate computing device 102 and may communicate with the separate computing device 102 using wired or wireless technologies (e.g. USB, Bluetooth™, Wi-Fi™, etc.). The touch-sensitive surface device 100 is capable of detecting and locating multi-touch user input (e.g. a user's fingers 104) and/or gestures and is additionally be capable of detecting and locating one or more objects 106 on the surface.

As shown in FIG. 1, the object 106 comprises a plurality of conductive regions 160 (e.g. three or more conductive regions 160) which are connected (e.g. individually) to a switching arrangement 162. The conductive regions 160 may be formed from metal or any other conductive material and in various examples, less conductive materials such as ITO (Indium Tin Oxide) or carbon, may be used. As shown in FIG. 1, the plurality of conductive regions 160 are all on the same face of the object; however, in other examples there may be a further plurality of conductive areas on a different face (e.g. the opposite face) of the object 106.

As also shown in FIG. 1, when the object 106 is placed on the touch-sensitive surface device 100 all the conductive regions 160 make contact with only one face, i.e. the top, sensing face of the touch-sensitive surface device 100 and there is no additional electrical (or physical) connection from the object to another face of the touch-sensitive surface device 100 or to the casing of the touch-sensitive surface device. In various examples, the object 106 may additionally comprise a short-range wireless tag 164 (e.g. an NFC or short-range RFID tag).

The switching arrangement 162 is configured to enable the capacitive footprint of the object 106 to be changed in some way. The switching arrangement 162 may comprise a processing element (e.g. a microcontroller) which selectively changes the capacitive footprint of the object by selectively shorting together two or more of the conductive regions 160 or by changing the relative position of two or more of the conductive regions 160. In addition, or instead, the switching arrangement 162 may comprise one or more user activated controls (e.g. switches/sliders that are latching, i.e. they maintain their state when a user removes their hand) such that a user can manually change the capacitive footprint of the object.

The touch-sensitive surface device 100 comprises a sensing mat or pad 108 and a sensing module 110. The sensing surface device 100 may also comprise a communication interface 112 arranged to communicate with the separate computing device 102. In other examples, however, the sensing surface device 100 may be integrated with a computing device (e.g. such that it comprises a processor 114, memory 116, input/output interface 118, etc.).

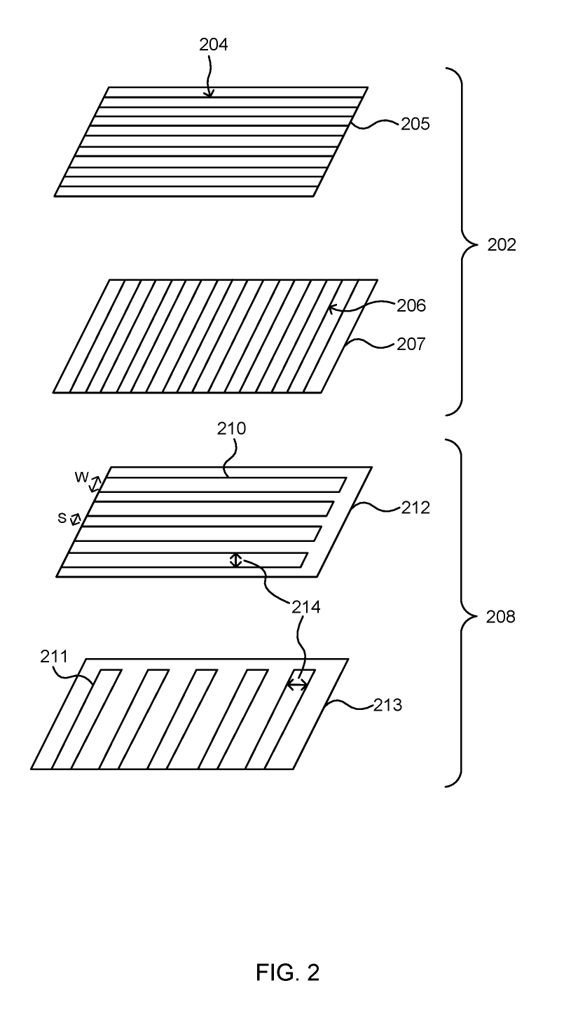

The sensing module 110 is configured to detect both the positions of objects 106 on the surface and a user touching the surface (e.g. with their fingers 104). The sensing mat 108 comprises a capacitive sensing electrode array 202 (as shown in FIG. 2) and in various examples may comprise one or more additional sensing arrays, e.g. one or more arrays of RF antennas 208 (as shown in FIG. 2) and in various examples the sensing mat 108 may be a multi-layer structure comprising one array overlaid over another array. Where the sensing mat 108 comprises two different arrays which use different sensing techniques, the sensing mat 108 (and hence the touch-sensitive surface device 100) may be described as being multi-modal.

FIG. 2 shows examples of two different arrays 202, 208 and as described above, the sensing mat 108 comprises a capacitive sensing electrode array 202 and in various examples may additionally comprise an array of RF antennas 208 and in examples where the sensing mat 108 comprises both arrays, the capacitive sensing electrode array 202 may be positioned above the array of RF antennas 208 (e.g. when in the orientation shown in FIG. 1 and with a user touching the uppermost, touch surface of the first part 108, as indicated by the hand 105 in FIG. 1), i.e. the capacitive sensing electrode array 202 is closer to the touch surface than the array of RF antennas 208. Having the capacitive sensing electrode array 202 closer to the touch surface than the array of RF antennas 208 enables the array of RF antennas to provide a shield beneath the capacitive sensing layer (e.g. to prevent false detection caused by objects underneath the sensing surface) and a ground touch return path for user's fingers.

In various examples where the sensing mat 108 comprises both arrays 202, 208, the two arrays 202, 208 may be substantially the same size so that the arrays overlap completely. In other examples, however, the two arrays may not be the same size (e.g. the capacitive sensing electrode array 202 may be larger than the array of RF antennas or vice versa) and/or the arrays may be partially offset from each other so that they do not overlap completely and such that there are portions of the sensing surface which are multi-modal (i.e. where the two arrays overlap) and there are portions of the sensing surface which are not (i.e. where there is only one of the two arrays 202, 208).

The capacitive sensing electrode array 202 shown in FIG. 2 comprises a first set of electrodes 204 in a first layer 205 and a second set of electrodes 206 in a second layer 207. In the example shown in FIG. 2 the two sets of electrodes 204, 206 are arranged perpendicular to each other such that one set may be referred to as the x-axis electrodes and the other set may be referred to as the y-axis electrodes. In other examples, however, the sets of electrodes may be arranged such that they are not exactly perpendicular to each other but instead the electrodes cross at a different angle. The sets of electrodes 204, 206 are separated by some insulation which may be in the form of an insulating layer (not shown in FIG. 2) or insulation over the wires that form one or both of the sets of electrodes 204, 206.

The array of RF antennas 208 shown in FIG. 2 comprises a plurality of loop antennas and the example in FIG. 2 the array 208 comprises two sets of antennas 210, 211 in two separate layers 212, 213; however, in other examples, the array of RF antennas 208 may comprise only a single set of antennas (i.e. one of the two sets 210, 211 shown in FIG. 2 may be omitted). Two sets of antennas, as shown in FIG. 2 may be provided to enable the sensing surface 100 to distinguish between two objects at different locations but which are both proximate to the same RF antenna (such that if there was only one set of antennas, a single RF antenna would be able to read the tags in both objects). Such a row/column arrangement of RF antennas (comprising two sets of antennas 210, 211 as shown in FIG. 2) also enables the sensing surface to scale better (i.e. to larger sizes of sensing surface) and makes scanning across the area to find an object faster. In an alternative arrangement, a matrix (or grid) of individual antennas (e.g. m by n antennas arranged in a grid) may be used. Such a grid does not scale as well as the arrangement shown in FIG. 2, but may enable addressing of an object at a known location to be performed faster.

In the example shown in FIG. 2 the two sets of antennas 210, 211 are arranged perpendicular to each other in a row/column matrix such that one set may be referred to as the x-axis antennas and the other set may be referred to as the y-axis antennas. In other examples, however, the sets of antennas may be arranged such that they are not exactly perpendicular to each other but instead the antennas cross at a different angle or there may be only a single set of antennas (i.e. one of the sets 210, 211 is omitted). The two sets of antennas 210, 211 are separated by some insulation which may be in the form of an insulating layer (not shown in FIG. 2) or insulation over the wires that form one or both of the sets of antennas 210, 211.

In examples where the sensing surface device 100 comprises both arrays, 202, 208, the two arrays 202, 208 are separated by a distance (e.g. by an insulating layer also not shown in FIG. 2) in order to reduce the mutual capacitance between the capacitive sensing electrodes and the ‘ground’ layer provided by the NFC antennas.

As shown in FIG. 2, the RF antennas may be substantially rectangular loop antennas with a width (as indicated by arrows 214) which is close to the sizes of wireless tag used in any objects which are to be identified (e.g. short-range wireless tag 164). For example, the width may be around 25 mm, with typical tag diameters being 17 mm, 22 mm, 25 mm, 30 mm and 35 mm, although larger tags are available (e.g. 50 mm diameters). Alternatively, other shapes of loop antenna may be used.

The loop antennas within each of the two sets 210, 211 may be equally spaced (where this spacing, s, between antennas is not necessarily the same as the width, w, of an antenna) or unequally spaced (and as described above, in some examples the antenna array 208 may only comprise a single set of antennas). Unequal spacing may, for example, be used to achieve variable resolution at various points on the sensing surface (e.g. to provide a sensing surface with lower resolution towards the edges and higher resolution in the middle) and this may, for example, enable the same number of antennas to be used for a larger sensing surface and for a smaller sensing surface. In an example, the loop antennas may be spaced so as to provide good coverage of the whole surface and to alleviate the effects of any nulls in the signal response of a single antenna.

The sensing mat 108 may, for example, be formed in a multi-layer flex circuit or using an embroidery of conductive traces onto a flexible substrate (e.g. woven into a fabric) to provide a flexible, yet robust, surface area. In an example, the sensing 108 may be sufficiently flexible that when not in use it can be rolled up around a second part 120 (which comprises the active electronics, e.g. the sensing module 110 and other optional elements 112-118) which may be rigid, e.g. for storage. In other examples, however, there may be no clear distinction between the sensing mat 108 and the electronics (e.g. the sensing module 110 and other optional elements 112-118) and instead the sensing module 110 etc. may be integrated within the sensing mat 108 or the distinction may be less (e.g. the sensing module 110 etc. may be formed in one or more additional layers underneath the sensing mat 108).

The sensing module 110 (which may comprise a microprocessor control unit, MCU) is coupled to the capacitive sensing electrode array 202 and is configured to detect both a decrease and an increase in the capacitance between electrodes in the array. A decrease of mutual capacitance between electrodes (i.e. between one or more electrodes in the first set of electrodes 204 and one or more electrodes in the second set of electrodes 206) is used to detect a user's fingers in the same way as conventional multi-touch sensing. Unlike conventional multi-touch sensing, however, the first sensing module 602 is also configured to detect an increase in the capacitance between electrodes in the array. An increase in mutual capacitance between electrodes (i.e. between one or more electrodes in the first set of electrodes 204 and one or more electrodes in the second set of electrodes 206) is used to detect the position and the shape of a conductive object on the surface, e.g. to detect the conductive footprint of an object 106 on the surface. Unlike a user's finger, such an object has no connection to ground and instead it capacitive couples adjacent electrodes (consequently, the object does not need to have a high electrical conductivity and instead can be made from, or include, any conductive material).

In examples where the sensing mat 108 additionally comprises an array of RF antennas 208, the sensing module 110 is coupled to the array of RF antennas 208 and is configured to selectively tune and detune the RF antennas in the array. For example, the sensing module 110 may deactivate all but a selected one or more RF antennas and then power the selected RF antennas such that they can activate and read any proximate wireless tags (e.g. short-range wireless tag 164, where the reading of tags using a selected antenna may be performed in the same way as a conventional NFC or RFID reader). Where more than one RF antenna is tuned and powered at the same time, these antennas are selected to be sufficiently far apart that there is no effect on one powered RF antenna from any of the other powered RF antennas. The deactivation of an RF antenna may be implemented in many different ways, for example by shorting the two halves of the loop via a transistor or making the tuning capacitors (which would otherwise tune the antenna at the right frequency) open-circuit (using a transistor). This selective tuning and detuning of the RF antennas stops the antennas from coupling with each other (e.g. such that the power is not coupled into another antenna, which may then activate tags proximate to that other antenna and not the original, powered antenna).

In examples where the sensing mat 108 comprises both a capacitive sensing electrode array 202 and an array of RF antennas 208, the sensing module 110 may be further configured to connect all the RF antennas to ground when detecting touch events using the capacitive sensing electrode array 202. This prevents the capacitive sensors from sensing activity on the non-touch-side of the sensing mat (e.g. legs under the table) and provides the capacitive return path to ground (which completes the circuit of the user's finger to the sensing electrodes to ground and to the user's body).

Depending upon the implementation of the sensing surface device 100, it may also comprise a communication interface 112 arranged to communicate with a separate computing device 102 using a wired or wireless technology. In various examples, the communication interface 112 may, in addition or instead, be arranged to communicate with an object 106 (e.g. following identification of the module by the sensing module 110).

In various examples, the sensing surface device 100 may be integrated with a computing device such that it further comprises the component parts of the computing device, such as a processor 114, memory 116, input/output interface 118, etc. In other examples, the sensing surface device 100 may be integrated within a peripheral for a separate computing device 102 e.g. within a keyboard.

The functionality of the sensing module 110 described herein may be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

In examples where the sensing surface device 100 is integrated with a computing device such that it further comprises the component parts of the computing device, such as a processor 114, memory 116, input/output interface 118, etc. the processor 114 may be a microprocessor, controller or any other suitable type of processor for processing computer executable instructions to control the operation of the device in order to implement functionality of the computing device (e.g. to run an operating system and application software).

The operating system and application software may be provided using any computer-readable media that is accessible by the sensing surface device 100. Computer-readable media may include, for example, computer storage media such as memory 116 and communications media. Computer storage media, such as memory 116, includes volatile and non-volatile, removable and non-removable media implemented in any method or technology for storage of information such as computer readable instructions, data structures, program modules or the like. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Propagated signals per se are not examples of computer storage media. Although the computer storage media (memory 116) is shown within the sensing surface device 100 it will be appreciated that the storage may be distributed or located remotely and accessed via a network or other communication link (e.g. using communication interface 112).

The sensing surface device 100 may also comprise an input/output interface 118 arranged to output display information to a display device which may be separate from or integral to the sensing surface device 100. The display information may provide a graphical user interface. The input/output interface 118 may also be arranged to receive and process input from one or more devices, such as a user input device (e.g. a mouse, keyboard, camera, microphone or other sensor). In some examples the user input device may detect voice input, user gestures or other user actions and may provide a natural user interface (NUI). The input/output interface 118 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

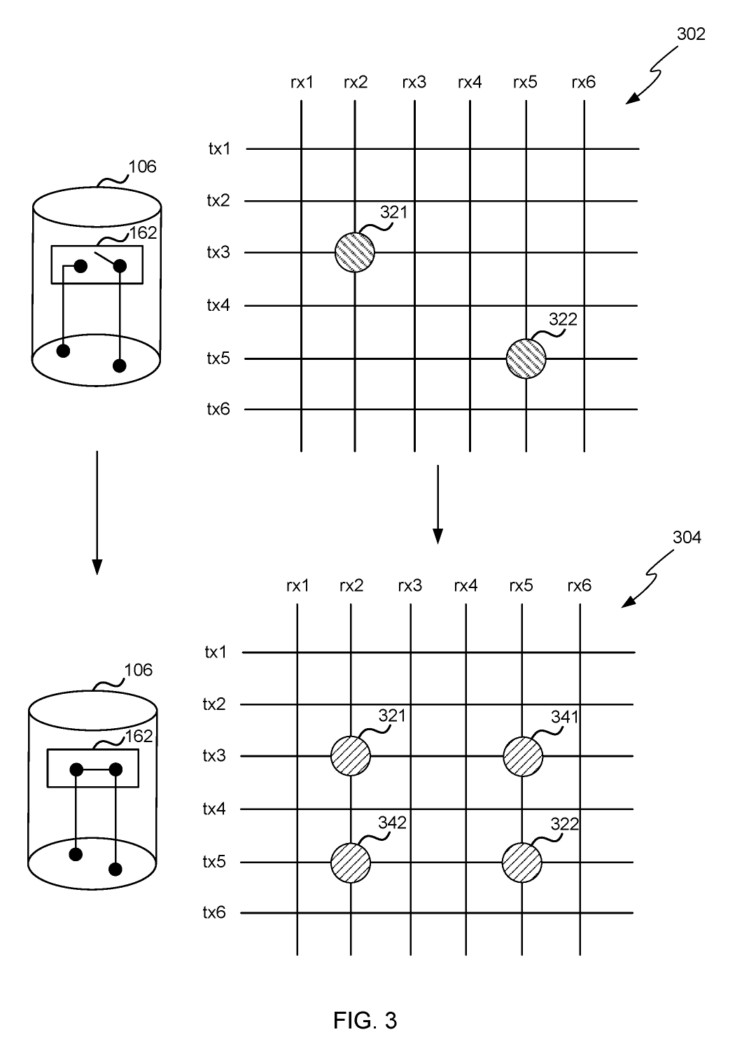

The operation of the object 106 and the sensing module 110 can be described with reference to FIG. 3 which shows an example object 106. The object 106 shown in FIG. 3 comprises two conductive regions 160 on the same face (the bottom face) of the object. As described above, the conductive regions 160 are connected to a switching arrangement 162 which in the example shown comprises a single switch which can be either open (as in the upper example 302) or closed (as in the lower example 304). The switch may be operated manually (e.g. by a user) or may be operated by a processing element (e.g. a microcontroller) not shown in FIG. 3. When the switch is open, the two conductive regions are electrically isolated from each other and when the switch is closed, the two conductive regions are electrically connected (i.e. shorted) together. By operating the switch, the capacitive footprint of the object is changed.

Also shown in FIG. 3 are the corresponding images sensed by the sensing module 110 using the capacitive sensing electrode array 202. These images show the change in capacitive footprint of the object 106. In the first example 302 (when the switch is open), the first conductive region 321 changes the coupling between sensor lines tx3 and rx2 and the second conductive region 322 changes the coupling between sensor lines tx5 and rx5 and this gives a first image. In the second example 304 (when the switch is closed), sensor lines tx3 and tx5 couple into both rx2 and rx5 and this produces a second image which comprises alias or ghost images of the conductive regions 341, 342, as shown in FIG. 3.

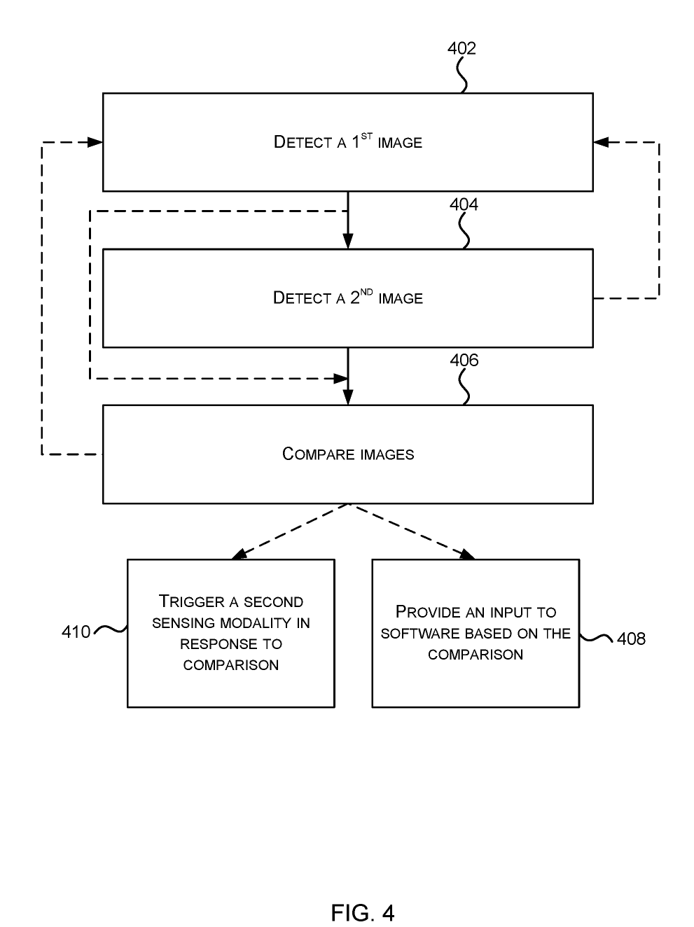

As shown in the flow diagram of FIG. 4, in various examples the sensing module 110 detects a first image (block 402), e.g. at time T1 when the switch is open and detects a second image (block 404), e.g. at time T2 when the switch is subsequently closed, where these images may alternatively be referred to as frames (e.g. a first frame at time T1 and a second frame at time T2). The sensing module 110 analyzes the detected images (block 406) and this may comprise comparing corresponding portions of any two or more detected images to identify any differences. If a difference is detected (in block 406), the difference may be used as an interrupt signal, for example which triggers the sensing module 110 to use a second sensing modality (block 410, e.g. an array of RF antennas 208, or a Bluetooth™ module). Alternatively (or in addition), the difference may encode data (e.g. one bit of data per frame or more than one bit per frame) and the sensing module 110 may generate an input to software running on the touch-sensitive surface device 100 or another computing device 102 based on the data, i.e. based on the detected difference (block 408).

In other examples, the sensing module 110 does not compare two detected images (in block 406) but instead compares a detected image (e.g. a first detected image, as detected in block 402) to one or more reference images—e.g. a reference image for each of a number of possible states. In such examples a second image may not be detected (e.g. block 404 may be omitted as indicated by the dotted arrow in FIG. 4). If the comparison (in block 406) identifies a match between the detected image and a reference footprint, this may be used as an interrupt signal, for example which triggers the sensing module 110 to use a second sensing modality (block 410, e.g. an array of RF antennas 208, or a Bluetooth™ module). Alternatively (or in addition), the matching reference state may correspond to a data item (e.g. one bit of data per frame or more than one bit per frame) and the sensing module 110 may generate an input to software running on the touch-sensitive surface device 100 or another computing device 102 based on the data, i.e. based on the detected match (block 408).

The sensing module 110 may comprise an image processing element which performs the comparison of images (in block 406). In various examples, the image processing element may use an algorithm such as a sum of magnitudes of the differences over a region of interest between frames. The region of interest may be the entire sensing area or a region of predefined size (e.g. there may be a predefined footprint size) or may be defined in another way. Any change detected using this algorithm may then be used as an interrupt signal (e.g. to trigger a second sensing modality in block 410 or for any other purpose) or to encode data (e.g. which is then provided as an input to software running locally or remotely in block 408). In other examples, the sensing module (e.g. an image processing element within the sensing module 110) may perform more complex signal processing on the detected images and this may improve the signal to noise ratio (SNR) or reliability. In various examples, filtering may be performed (e.g. spatial and/or temporal filtering) to exclude those changes which may be caused by other factors, e.g. an object being moved.

Although FIG. 3 shows two images, the analysis may involve the comparison of more than two images and so the detection elements of the method (e.g. blocks 402-404) may be repeated (as indicated by a dotted arrow in FIG. 4).

In examples where the sensing surface is multi-modal (e.g. it comprises a capacitive sensing electrode array 202 and an array of RF antennas 208, as described above with reference to FIG. 2), a change in the capacitive footprint (and hence the detected image) of the object or a match to a reference footprint may provide an interrupt signal which triggers the use of the second sensing modality (in block 410). For example, in response to detecting a change in the capacitive footprint of an object 106 or detecting a match to a reference ‘interrupt’ footprint, the sensing module 110 may activate an RF antenna which is proximate to the object in order to read data from a short-range wireless tag 164 in the object 106. The data that is read from the short-range wireless tag 164 may, for example, comprise an identifier for the object and/or state information for the object.

In the example shown in FIG. 3, the switching arrangement 162 comprises a single switch and this may be a mechanical switch, such as a push button or a magnetically operated reed switch. In other examples (e.g. where there are more than two conductive regions 160 on the single face of the object), there may be additional switches and/or other components within the switching arrangement 162.

In various examples, the switching arrangement 162 may be configured to have a very low “off” capacitance and a very high “off” resistance (i.e. when the conductive regions are not connected together they have little/no capacitive coupling and a very high resistance between them) in order that the contrast between the images (i.e. the detected patterns) in the “off” state (e.g. with the switch open) and the “on” state (e.g. with the switch closed) is high. As the leakage resistance and capacitance between the conductive regions (i.e. the resistance and capacitance between regions when they are not intentionally shorted together) increases, the difference between the two images in the “on” (or connected) and “off” (or not connected) states drops. For example, referring to FIG. 3, there may be faint ghost electrodes visible even when the switch is open.

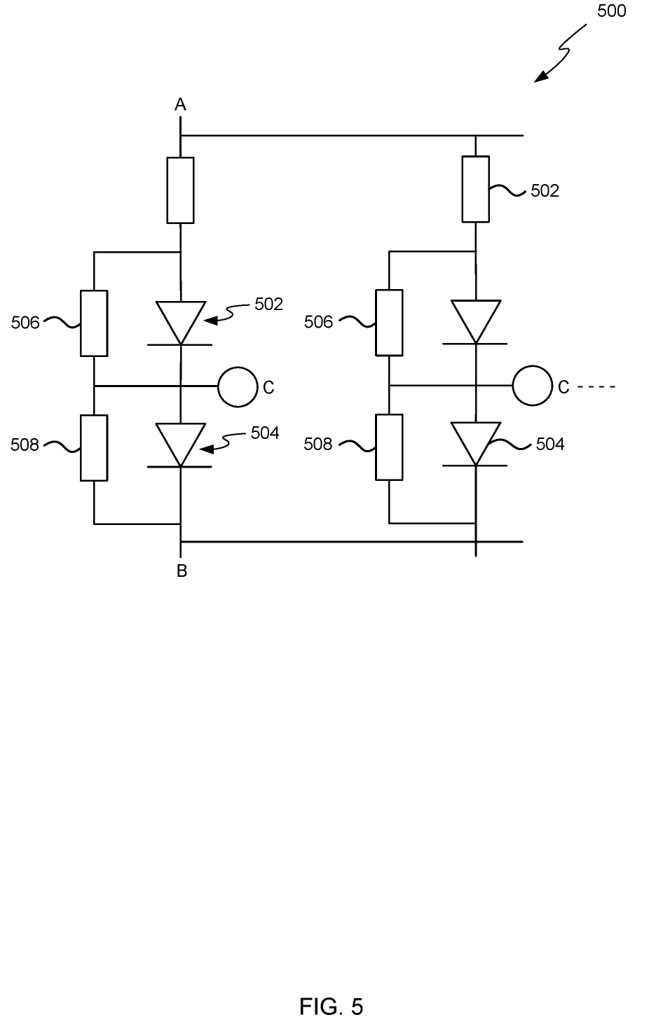

FIG. 5 shows an example switching arrangement 500 which is electronically controllable (e.g. by a microcontroller or other processing element) and which has a low capacitance between electrodes in the “off” state (i.e. when not intentionally shorted together) and uses very little power. In this example, reverse bias is applied to A-B to switch off the diodes 502, 504 and a small leakage current (e.g. of the order of nA or μA) will flow through the diodes 502, 504 and high value balancing resistors 506, 508. This will turn off the diodes 502, 504 and put them in a low capacitance state that will isolate the electrodes C from each other. A forward bias can be applied to A-B to turn on the diodes 502, 504 to a low resistance “on” state and connect the electrodes to each other (and to other parts of the circuit). As a consequence of the high impedance nature of a capacitive sensing electrode array, the “on” resistance can be quite high (e.g. of the order of kΩ) and still operate as if the electrodes are shorted together. This means that only a small current (e.g. of the order of μA) is needed to put the switch in the “on” state and such a current can be provided by a microcontroller or other processing element (not shown in FIG. 5) within the switching arrangement 500.

It will be appreciated that the example switching arrangement 500 shown in FIG. 5 is only one possible example and the switching arrangement may have other forms (e.g. a very low capacitance transistor, a MEMS device, etc.).

In the examples shown in FIGS. 4 and 5, the object comprises only two conductive regions on the same face. This means that where the capacitive sensing electrode array is in an x-y grid (e.g. as shown in FIGS. 2 and 3) there is a possibility that both conductive regions fall on the same sensing line. This would mean that the ghost images will fall on top of the real electrode positions and no difference can be detected (in block 406). To avoid this, a different arrangement of conductive regions or sensing lines may be used.

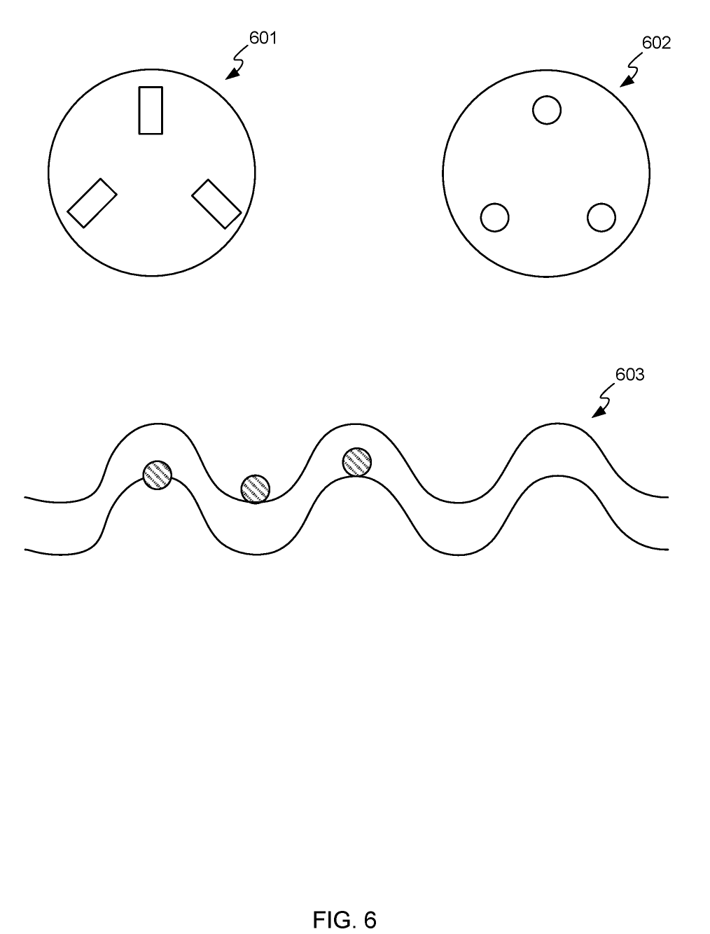

In various examples, the object may comprise three or more conductive regions on the same face which do not all fall on a single straight line (and which are all connected to the sensing arrangement), e.g. as shown in the first two examples 601, 602 in FIG. 6. By having three or more conductive regions which are not arranged in a line, the conductive regions cannot all fall on the same sensing line in an x-y grid of sensing lines, irrespective of the rotational orientation of the object when placed on the touch-sensitive surface device. In another example, the sensing lines in the touch-sensitive surface device may be undulating (or otherwise non-straight) instead of being straight and the object may comprise three or more conductive regions on the same face which are arranged in a straight line, as shown in the third example 603 in FIG. 6.

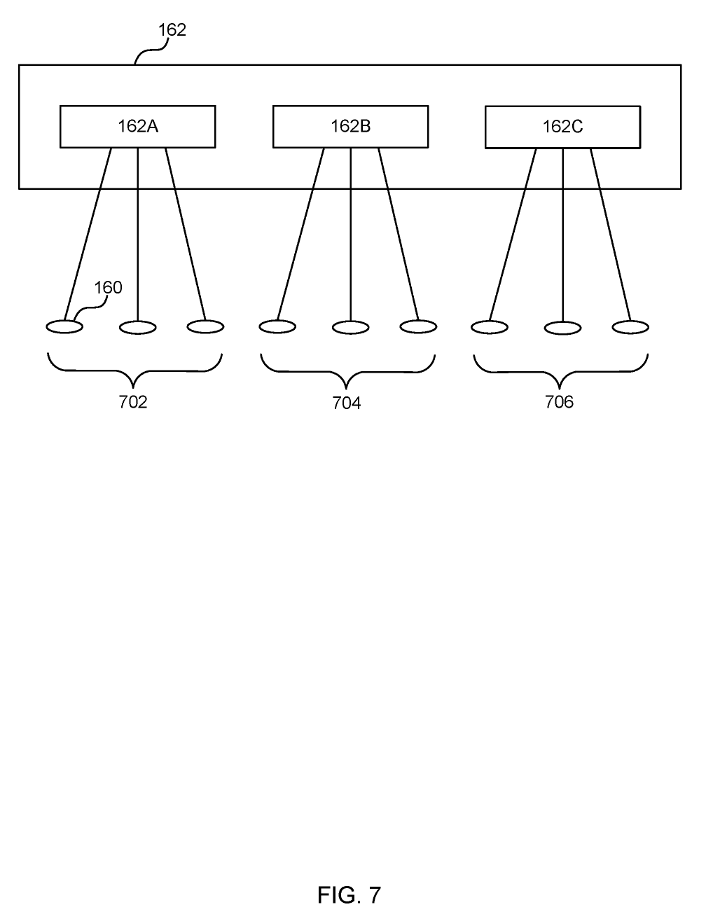

Use of three or more conductive regions may additionally, or instead, enable the object to encode more than one bit of information per frame of capacitive sense measurements (e.g. per detected image, as compared to the immediately previous detected image). This information may, for example, be used to send an identifier or encode multiple sensor states (e.g. many switches) or quantize an analog sensor, etc. These three or more conductive regions may, for example, be arranged in groups, with each group encoding a bit of information and an example is shown in FIG. 7. In the example shown in FIG. 7, the object comprises nine conductive regions 160 arranged in three groups of three 702, 704, 706. The switching arrangement 162 is configured to selectively connect the conductive regions within a group together and can independently connect each group together. This enables the encoding of three bits of data per frame, as shown in the table below:

| 1^{st} Group 702 | 2^{nd} Group 704 | 3^{rd} Group 706 | Encoded data |
|---|---|---|---|
| Not connected | Not connected | Not connected | 000 |
| together | together | together | |
| Connected | Not connected | Not connected | 100 |
| together | together | together | |
| Not connected | Connected | Not connected | 010 |
| together | together | together | |
| Not connected | Not connected | Connected | 001 |
| together | together | together | |
| Connected | Connected | Not connected | 110 |
| together | together | together | |
| Not connected | Connected | Connected | 011 |
| together | together | together | |
| Connected | Not connected | Connected | 101 |
| together | together | together | |
| Connected | Connected | Connected | 111 |
| together | together | together | |

In the example shown above, each group of conductive regions that can be selectively connected together can communicate a single bit of information per frame (e.g. one bit/frame for the object in FIG. 4 and three bits/frame for the object in FIG. 7). In various examples, however, if the SNR is high enough, the switching arrangement 162 may encode more than one bit of information per frame using a group of conductive regions, e.g. by having more levels than ‘connected together’ and ‘not connected together’ (as was the case in the example above). For example, the conductive regions within a group may be connected through a set of different or continuously variable resistances or capacitances and this may result in different levels within the detected image (e.g. analogous to a greyscale image instead of using just black and white, QAM vs QAM-16, etc.).

In various examples, the touch-sensitive surface device may operate at up to 200 frames per second which enables a data rate of up to 200 bits (or symbols)/frame/group for the communication from the object to the touch-sensitive surface device. In other examples, more than 200 frames per second may be used, thereby enabling higher data rates. Techniques such as coding and forward error correction may be applied to reduce the errors in the one-way communication channel from the object to the touch-sensitive surface device.

By using these methods, the data rate of the one-way communication channel (from the object to the touch-sensitive surface device) may be sufficient to communicate an identifier for the object to the touch-sensitive surface device. Consequently, the touch-sensitive surface device may be able to identify the object on the surface using only capacitive sensing (e.g. to uniquely identify the object, where the data communicated is a unique ID for the object). This may avoid the need to provide or use a second sensing modality (e.g. NFC) or communication channel (e.g. Bluetooth™) and hence reduce the size, complexity and/or overall power consumption of the touch-sensitive surface device. A low power consumption may, for example, be particularly important if the touch-sensitive surface device is battery powered because it increases the operating life of the battery (e.g. between charges in the case of a rechargeable battery). The size of the sensing surface may, for example, be particularly important where it is integrated into a handheld computing device or peripheral device.

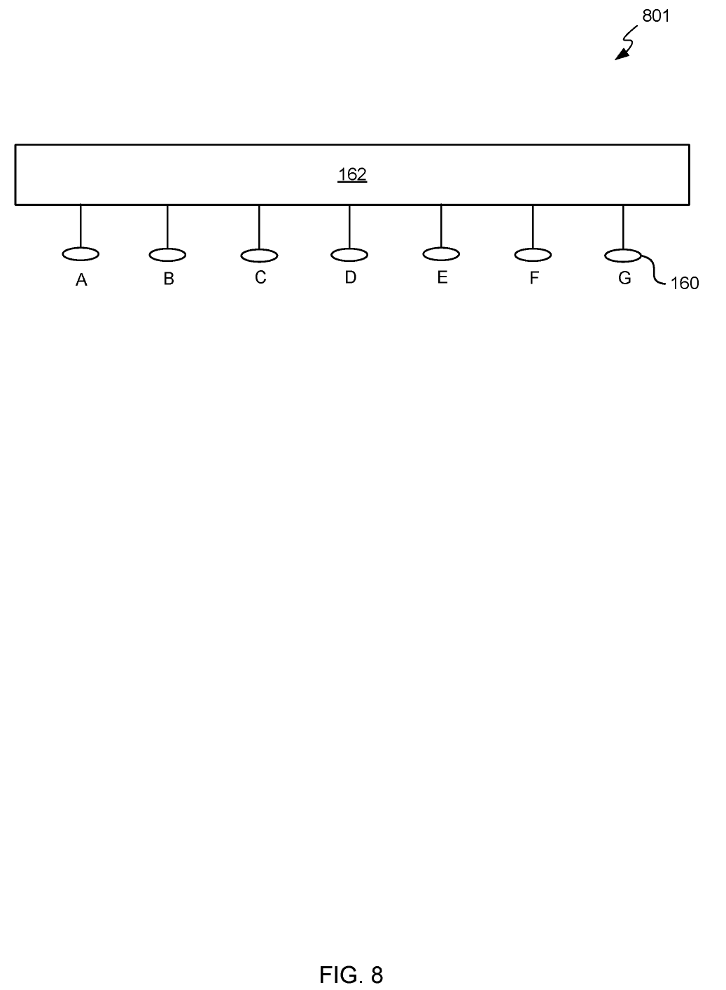

In the examples described above with reference to FIGS. 3 and 7, the conductive regions within a group are either all connected (e.g. shorted) together or all not connected (e.g. shorted) together and this is used to encode data. In other examples, however, data may be encoded by the object using the relative position (e.g. the spacing) of conductive regions which are connected together and this can be described with reference to FIG. 8. In the example 801 shown in FIG. 8, an object comprises seven conductive regions 160 (e.g. which may be equally spaced or arranged in any pattern) and the switching arrangement may be arranged to selectively connect a predefined number (e.g. two or three) together and where data is encoded by connecting different combinations of conductive regions together. An example is shown in the table below, with the Xs indicating the conductive regions which are connected together by the switching arrangement 162:

| A | B | C | D | E | F | G | Data |
|---|---|---|---|---|---|---|---|
| | | | | | | | 000 |
| X | X | | | | | | 001 |
| X | | X | | | | | 010 |
| X | | | X | | | | 011 |
| X | | | | X | | | 100 |
| X | | | | | X | | 101 |
| X | | | | | | X | 110 |

Using the object and methods described above, data may be communicated (e.g. 1 bit in the form of an interrupt signal or multiple bits) from an object to the touch-sensitive surface device in parallel with touch detection and/or object tracking (e.g. in other areas on the touch-sensitive surface device) which may be performed using known methods.

As described above, the communication channel between the object and the touch-sensitive surface device which is implemented by the combination of the plurality of conductive regions 160 and the switching arrangement 162 is passive switching and does not inject a signal (e.g. from the object to the touch-sensitive surface device) and therefore it is inherently a low/no power solution.

Although in the examples described above the image processing is implemented within the sensing module 110, in other examples, the touch-sensitive surface device may comprise standard hardware (e.g. a standard touch-screen device) running new image processing software which implements the methods described above (e.g. where the image processing software may be stored in memory 116 and executed by the processor 114). In various examples the image processing software which implements the methods described herein (e.g. as shown in FIG. 4) may, for example, be integrated within an application or the operating system.

Although the examples described above and shown in the accompanying drawings only comprise conductive regions which are connected to the switching arrangement 162, it will be appreciated that in various examples there may be other conductive regions which are not connected to the switching arrangement 162 and therefore contribute a static, non-changeable element to the capacitive footprint of the object. Such additional conductive regions may, for example, be used to encode static information (e.g. a particular pattern which indicates an object type).

Although the present examples are described and illustrated herein as being implemented in a sensing system as shown in FIG. 1, the system described is provided as an example and not a limitation. As those skilled in the art will appreciate, the present examples are suitable for application in a variety of different types of sensing systems and the sensing mat, for example, may be of any size or shape and may be contoured instead of being flat (as shown in FIG. 1).

A first further example provides an object for use with a capacitive-touch-sensing device, the object comprising: a plurality of conductive regions on a single face of the object; and a switching arrangement connected to the plurality of conductive regions and configured to change a capacitive footprint of the face of the object.

The switching arrangement may be configured to change the capacitive footprint of the face of the object by selectively connecting two or more of the conductive regions together.

The switching arrangement may comprise a processing element configured to selectively connect two or more of the conductive regions together.

The switching arrangement may comprise a user input device and a latching arrangement configured to maintain a change in connectively of the conductive regions after a user has stopped touching the user input device.

The plurality of conductive regions may comprise a plurality of groups of conductive regions, each group comprising two or more conductive regions, and wherein the switching arrangement is configured to change the capacitive footprint of the face of the object by selectively connecting the conductive regions within a group together.

The switching arrangement may be configured to change the capacitive footprint of the face of the object by selectively connecting a subset of the conductive regions together.

The switching arrangement may comprise a plurality of paths with different resistance and/or capacitance and is configured to change the capacitive footprint of the face of the object by selectively connecting two or more of the conductive regions together via a selected one of the plurality of paths with different resistance and/or capacitance.

The switching arrangement may comprise a mechanical slider arranged to adjust a physical spacing between at least two of the conductive regions on the face of the object.

The plurality of conductive regions may comprise three or more conductive regions.

A second further example provides a sensing surface device comprising: a sensing mat comprising a capacitive sensing electrode array; and a sensing module coupled to the sensing mat and configured to: detect a first image using the sensing mat; compare a portion of the first image to a second image, the portion of the first image corresponding to an object on the sensing mat and the second image comprising a second image detected using the sensing mat or a stored reference image; and in response to detecting a difference between portions of the first and second detected images indicative of a change in capacitive footprint of the object or detecting a match between the first detected image and the stored reference image, to trigger an action.

The sensing module may be arranged, in response to detecting a difference between portions of the first and second detected images or to detecting a match between the first detected image and the stored reference image, to raise an interrupt.

The sensing module may be arranged, in response to detecting a difference between portions of the first and second detected images or detecting a match between the first detected image and the stored reference image, to trigger sensing using a second sensing modality.

The sensing surface may further comprise an array of RF antennas and wherein the sensing module is arranged, in response to detecting a difference between portions of the first and second images, to trigger sensing using the array of RF antennas.

The sensing module may be arranged, in response to detecting a difference between portions of the first and second images, to provide an input to software based on the detected difference.

The sensing module may be arranged to detect both an increase and a decrease in capacitance between electrodes in the capacitive sensing electrode array.

A third further example provides a method of communication between an object on a touch-sensitive device and the touch-sensitive device, the method comprising: detecting, using a capacitive sensing electrode array in the touch-sensitive device, a first image; detecting, using the capacitive sensing electrode array in the touch-sensitive device, a second image; comparing a portion of the first image and a portion of the second image; and in response to detecting a difference between the portion of the first image and the portion of the second image indicative of a change in capacitive footprint of the object, triggering an action in the touch-sensitive device.

Triggering an action may comprise: triggering sensing by the touch-sensitive device using a second sensing modality.

The touch-sensitive device may comprise an array of RF antennas and wherein triggering sensing by the touch-sensitive device using a second sensing modality comprises: triggering sensing by the touch-sensitive device using the array of RF antennas.

Triggering an action may comprise: providing an input to software based on the detected difference.

The method may further comprise, within the object: selectively connecting together two or more conductive regions on a face of the object in contact with the touch-sensitive device.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An object for use with a capacitive-touch-sensing device, the object comprising:
a plurality of conductive regions on a single face of the object; and
a switching arrangement connected to the plurality of conductive regions and configured to change a capacitive footprint of the face of the object.

2. The object according to claim 1, wherein the switching arrangement is configured to change the capacitive footprint of the face of the object by selectively connecting two or more of the conductive regions together.

3. The object according to claim 2, wherein the switching arrangement comprises a processing element configured to selectively connect two or more of the conductive regions together.

4. The object according to claim 2, wherein the switching arrangement comprises a user input device and a latching arrangement configured to maintain a change in connectively of the conductive regions after a user has stopped touching the user input device.

5. The object according to claim 2, wherein the plurality of conductive regions comprises a plurality of groups of conductive regions, each group comprising two or more conductive regions, and wherein the switching arrangement is configured to change the capacitive footprint of the face of the object by selectively connecting the conductive regions within a group together.

6. The object according to claim 2, wherein the switching arrangement is configured to change the capacitive footprint of the face of the object by selectively connecting a subset of the conductive regions together.

7. The object according to claim 2, wherein the switching arrangement comprises a plurality of paths with different resistance and/or capacitance and is configured to change the capacitive footprint of the face of the object by selectively connecting two or more of the conductive regions together via a selected one of the plurality of paths with different resistance and/or capacitance.

8. The object according to claim 1, wherein the switching arrangement comprises a mechanical slider arranged to adjust a physical spacing between at least two of the conductive regions on the face of the object.

9. The object according to claim 1, wherein the plurality of conductive regions comprises three or more conductive regions.

10. A sensing surface device comprising:
a sensing mat comprising a capacitive sensing electrode array; and
a sensing module coupled to the sensing mat and configured to:
detect a first image using the sensing mat;
compare a portion of the first image to a second image, the portion of the first image corresponding to an object on the sensing mat and the second image comprising a second image detected using the sensing mat or a stored reference image; and
in response to detecting a difference between portions of the first and second detected images indicative of a change in capacitive footprint of the object or detecting a match between the first detected image and the stored reference image, to trigger an action.

11. The sensing surface device according to claim 10, wherein the sensing module is arranged, in response to detecting a difference between portions of the first and second detected images or to detecting a match between the first detected image and the stored reference image, to raise an interrupt.

12. The sensing surface device according to claim 11, wherein the sensing module is arranged, in response to detecting a difference between portions of the first and second detected images or detecting a match between the first detected image and the stored reference image, to trigger sensing using a second sensing modality.

13. The sensing surface device according to claim 12, further comprising an array of RF antennas and wherein the sensing module is arranged, in response to detecting a difference between portions of the first and second images, to trigger sensing using the array of RF antennas.

14. The sensing surface device according to claim 10, wherein the sensing module is arranged, in response to detecting a difference between portions of the first and second images, to provide an input to software based on the detected difference.

15. The sensing surface device according to claim 10, wherein the sensing module is arranged to detect both an increase and a decrease in capacitance between electrodes in the capacitive sensing electrode array.

16. A method of communication between an object on a touch-sensitive device and the touch-sensitive device, the method comprising:
detecting, using a capacitive sensing electrode array in the touch-sensitive device, a first image;
detecting, using the capacitive sensing electrode array in the touch-sensitive device, a second image;
comparing a portion of the first image and a portion of the second image; and
in response to detecting a difference between the portion of the first image and the portion of the second image indicative of a change in capacitive footprint of the object, triggering an action in the touch-sensitive device.

17. The method according to claim 16, wherein triggering an action comprises:
triggering sensing by the touch-sensitive device using a second sensing modality.

18. The method according to claim 17, wherein the touch-sensitive device comprises an array of RF antennas and wherein triggering sensing by the touch-sensitive device using a second sensing modality comprises:
triggering sensing by the touch-sensitive device using the array of RF antennas.

19. The method according to claim 16, wherein triggering an action comprises:
providing an input to software based on the detected difference.

20. The method according to claim 16, further comprising, within the object:
selectively connecting together two or more conductive regions on a face of the object in contact with the touch-sensitive device.
